(19) United States
(12) Patent Application Publication
(10) Pub. No.: US 2010/0153194 A1
(43) Pub. Date: Jun. 17, 2010

(54) System, Device and Method for Incorporating Randomly Selected Prizes with Transactions

(76) Inventor: Thomas K. Oram, Hudson, MA (US)

Correspondence Address: Thomas F. Bergert;c/o WILLIAMS MULLEN IP docketing, 222 CENTRAL PARK AVENUE, SUITE 1700, VIRGINIA BEACH, VA, 23462, US

(21) Appl. No.: 12/401,679

(22) Filed: Mar. 11, 2009

Related U.S. Application Data
(60) Provisional application No. 61/122,179, filed on Dec. 12, 2008.

(51) Int. Cl. G06Q 30/00; G06Q 10/00; G06Q 40/00

(52) U.S. Cl. 705/14.1; 705/30

(57) ABSTRACT

The present invention provides a system, method and device for issuing random benefits to users of transaction cards and other personally identifying transaction instruments. The present invention provides a network accessible by various input devices or terminals, wherein the devices can receive a personally identifying transaction instrument and determine a user account associated therewith. When the personally identifying transaction instrument is presented as part of a transaction, the system of the present invention determines whether the user is to receive a benefit. If so, the system of the present invention selects a benefit at random from a pool of benefits and presents it to the user.

### CROSS-REFERENCE TO RELATED APPLICATIONS

The present application claims the benefit of U.S. Provisional Application Ser. No. 61/122,179, filed Dec. 12, 2008, entitled “System, Device and Method for Paperless Wagering and Payment of Winnings,” which is incorporated herein by reference in its entirety.

### BACKGROUND OF THE INVENTION

The lottery and gaming industry provides games involving unpredictable winners and winning amounts. For example, game players purchase lottery tickets in advance of knowing whether the ticket is a winner or loser, or the amount of any win. This uncertainty generates excitement and anticipation for game players.

While players of lottery and other wagering games generally have the ability to acquire a “player card” for, among other things, participating in rewards and benefits programs, such rewards and benefits are typically pre-determined and based on purchase amounts and/or frequency of use. Such programs are similar to traditional payment or non-lottery loyalty card programs, and do not randomize the benefit to the user.

### BRIEF SUMMARY OF THE PRESENT INVENTION

The present invention provides the excitement and anticipation of games of chance to users of different types of identifiers during purchase and other transactions. In one embodiment, the present invention provides a randomly selected benefit from a pool of available benefits upon use of the identifier during a transaction. The amount of the benefit is determined wholly or partly via random chance, rather than just by the purchase amount or other typical metric. As a result, a participating user can experience the same excitement and anticipation accompanying a game when making ordinary purchases. Further, the sponsoring organization benefits by adding an element of chance otherwise unavailable to its customers, thereby incentivizing potential customers to conduct transactions. The method of the present invention can be employed in any transaction or loyalty card setting, and further can employ lottery and gaming related rewards and prizes as the benefit. For example, when a participating user makes a purchase with a transaction card that is identified by the system of the present invention, the user may receive a random number of instant lottery tickets.

In one embodiment, the present invention provides a system, method and device for issuing random benefits to users of transaction cards and other personally identifying transaction instruments. The present invention generates and stores an initial pool of prizes as part of a rewards program hosted on a rewards data processing system. The rewards data processing system is accessible over a network, which in turn provides access to various input devices, such as retail point-of-sale terminals, computers and mobile communications devices, for example. The input devices are capable of receiving input from one or more types of personally identifying transaction instruments and forwarding the input to the rewards data processing system for determining an associated user account. When the personally identifying transaction instrument is presented as part of a transaction, the system of the present invention generates a random index into the pool of prizes and selects a prize to present to the user in one form or another. In one embodiment of the present invention, prior to generating the random index and selecting a prize, the system of the present invention first determines whether the user is to receive a benefit. If so, the system of the present invention then selects a benefit at random from a pool of benefits and presents it to the user. The pool can optionally be depleting or replenishing in nature, or a combination depleting and replenishing.

### BRIEF DESCRIPTION OF THE DRAWINGS

FIG. 1 is a schematic diagram illustrating one embodiment of a system of the present invention incorporating a rewards system backend and a traditional commercial transaction system backend.

FIG. 2 is a flow diagram illustrating prize pool creation and prize selection and issuance steps in accordance with one aspect of the present invention.

FIG. 3 is a diagram illustrating two methods of reporting winnings associated with one aspect of the present invention.

FIG. 4 is a schematic diagram illustrating a lottery data processing system as implemented in accordance with the present invention.

### DETAILED DESCRIPTION OF INVENTIVE ASPECTS OF THE INVENTION

As used in the present application, the term “personally identifying transaction instrument” can include or be associated with, by way of example and without limitation, a debit card, a credit card, a smart card, a gift card, a pre-paid card, a stored value card, a bank card, a player card, a “frequent-player” card, a user name and password combination, an account identifier, indicia such as a bar code or a magnetic stripe, a human biological identifier, a voucher, a radio frequency identification (RFID) tag or transmitter, an ATM card, a combination card, any other coded indicia, Bluetooth™-enhanced devices, mobile communications devices adapted for use with the above, or combinations of any of the above. The personally identifying transaction instrument is or can represent a personal identifier specific to an individual person, a group, a retailer, a chain of stores, or a specific device, as exemplified above. The personally identifying transaction instrument can further be associated with a unique identifier such as a credit or debit card number, serial number, account number, IP address, or e-mail address, for example.

If a card is employed as the personally identifying transaction instrument, its form factor can preferably be similar to that of a standard credit, debit or stored value card, and can operate similarly thereto. The card can implement contact technology such as magnetic stripes, and/or contact-less technology such as scannable barcodes, radio frequency identification (RFID) tags or Bluetooth™, for example. In one embodiment of the present invention, a mobile communications device can be employed as the personally identifying transaction instrument, based, for example, on the IP address of the device or a barcode or other identifier displayed on, and capable of being read from, the visual display of the device. In a further aspect of the present invention, the personally identifying transaction instrument can be the player himself or herself, or a part of the player, wherein the player's personal biological information (e.g., fingerprint, retina scan, voice or other human biologically unique information) can be recorded and stored with his or her account as part of his or her player information, and then compared with the biometric information measured when the user desires to initiate a transaction using the system of the present invention.

In one aspect of the present invention, the personally identifying transaction instrument can be used to determine an amount held in an account associated with the instrument or identifier, as well as to debit or credit amounts in the account, transfer funds from another account, and/or transfer gaming winnings into the account. The account associated with the personally identifying transaction instrument can be, for example, a debit or credit card account, a bank account, a savings account, a lottery account, a checking account, and/or another financial account. The account can be a financial institution account (e.g., Bank of America™ checking, savings or brokerage account) or a financial account maintained independently of a financial institution.

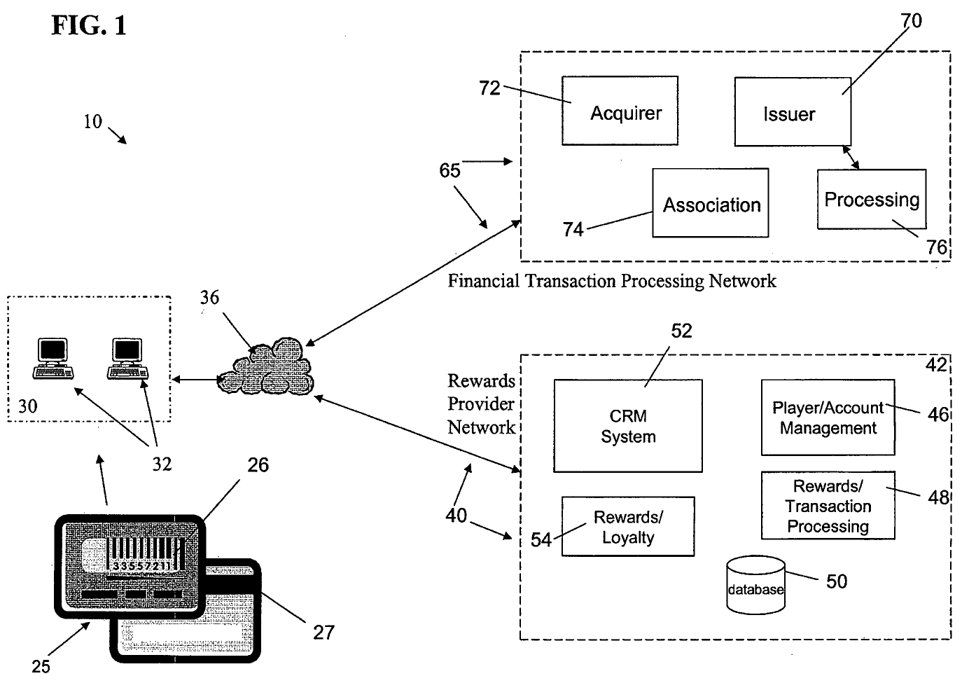

In one embodiment of the present invention, the personally identifying transaction instrument takes the form of a multi-purpose transaction card capable of serving, for example, as a credit or debit card as well as a loyalty card. An example such card is shown at 25 in FIG. 1, with a machine readable barcode 26 on one side of the card and a machine readable magnetic stripe 27 on the other side. It will be appreciated that these and other indicia may appear on the same side of the card in an alternative embodiment of the present invention. In one embodiment of the present invention, the multi-purpose transaction card includes indicia in the form of a visible computer chip on one face of the card, which is employed when the multi-purpose transaction card operates as a “smart card” capable of being read and written to by a reader or terminal in accordance with the present invention. The smart card implementation can employ either a local card memory or a complete local central processing unit (CPU) for added data storage and processing capability.

As further shown in FIG. 1, a typical implementation of the present invention involves a user identifying him or herself with a personally identifying transaction instrument, such as card 25, to a terminal 32. Each terminal can be provided with one or more methods of “reading” the identifiers and identifying individual players, such as, but not limited to, a browser interface, a biometric identifier such as a fingerprint scanner, a magnetic stripe reader, or a barcode reader. The POS terminal 32 can be a network-connected personal computer in one embodiment of the present invention with a communications component for permitting electronic communications according to known methods, wherein the computer can be located in a retail establishment 30 or even on the user's person (e.g., a mobile communications device) or in the user's own home. Since electronic commerce permits nearly ubiquitous transactions, any electronic communications device that can access the network of the present invention can be considered a POS terminal for purposes of the present disclosure. In one embodiment, the terminal is a reader terminal (i.e., a self-contained processing device or terminal that is adapted with a reader unit), wherein the reader is capable of reading and/or writing to magnetic stripes, chips and/or barcodes but not capable of reading biological identifiers (i.e., biometric signatures). In another embodiment, the terminal is a reader terminal that can read and/or write to magnetic stripes, chips and/or barcodes as well as biological identifiers. In a further embodiment, the terminal is a reader terminal that has no magnetic stripe, chip or barcode reading or writing capability but can read biometric information in order to personally identify a user of the present invention.

Readers that can be employed with the terminals of the present invention can include, for example, a magnetic stripe reader, a barcode scanner, a magnetic stripe or other smart card writer for writing information to a card, a fingerprint reader, a retinal eye scanner or the other reader types discussed elsewhere herein. The reader can be employed with an attended POS terminal in a retail store or other commercial location, a self-contained kiosk in a retail store or other commercial location, or the mobile equivalent of the self-contained kiosk (e.g., a home personal computer or user mobile communication device). The reader can be interfaced with the terminal by any of a variety of known computer interfaces, including USB port, PCMCIA slot, parallel port, floppy disk slot, infrared IRDA port, RS232 serial port or keyboard, for example.

As further shown in FIG. 1, the terminal 32 is in communication with a rewards provider network 40 via network 36, which can be a public network such as the Internet or a private network, for example. The rewards provider network 40 connects to a rewards data processing system 42, which can coordinate and/or run various rewards provider functions such as player and account management component 46, rewards transaction processing component 48, database 50, customer relationship management (CRM) component 52 and loyalty rewards component 54. Component 48 can include, for example, programming for generating prize pools, randomizing winners, benefits and prizes, managing reward distribution and communications. In another embodiment of the present invention, the rewards data processing system 42 can communicate with a financial system network 65 to manage electronic funds transfers for similar purposes. For instance, the rewards data processing system 42 can communicate the winnings from a prize selection to the financial system network in order to add funds to a financial institution account associated with a player, retailer or other entity, as described in more detail hereinafter.

In one embodiment of the present invention, the financial system network 65 is an association network (such as MasterCard™/VISA™ network), which manages rewards-related transactions in the customary way through communications between a card issuing bank 70, a transaction acquiring bank 72 and an association 74 (e.g., MasterCard™/VISA™). The card issuing bank can include a bank or financial institution data processing system 76 for managing account transactions. The financial institution data processing system includes programming for, among other things, initiating the opening of a financial institution account. In one embodiment of the present invention, an account can be opened and funded with a balance in the amount of winnings from a prize selected during the course of a qualifying transaction for a given user. Accounts can also be established and associated with specific rewards program sponsoring entities. For example, a retailer desiring to sponsor a rewards program in accordance with the present invention may have retailer-specific credit cards, where the underlying credit card program infrastructure and processing is managed by data processing system 76.

The present invention can accommodate specific card-type protocols according to the card-type employed. Thus, for example, the present invention employs barcode and magnetic stripe communication protocols to enable the implementation of a system that can handle cards with barcode and magnetic stripe indicia thereon. Smart card and contactless smart card (e.g., RFID) communication protocols are also provided by the present invention for deployments that involve cards with smart card and/or contactless capabilities. In addition, appropriate memory and processing power are provided depending upon the card and processing system requirements for any given deployment. Further, appropriate security hardware and software measures are employed as will be appreciated in accordance with typical measures provided for electronic commerce transactions.

The terminal, in whatever form, acts as the link between the user of the personally identifying transaction instrument (e.g., multi-purpose transaction card, biological identifier, etc.) and the computing system that executes the software of the present invention. The software provides the programming for executing the various functions and features of the present invention including, by way of example and not limitation, communications, security, credit or debit card processing via financial institution network and data processing system, benefit operation including rewards and prizes, randomization, account management, transaction management, reporting, settlement, point-of-sale, player management, game management and hardware management. The present invention software is further adapted appropriately to interface with third party software that may accompany any third party hardware used in accordance with the present invention, such as, for example, reader software associated with a hardware terminal reader element.

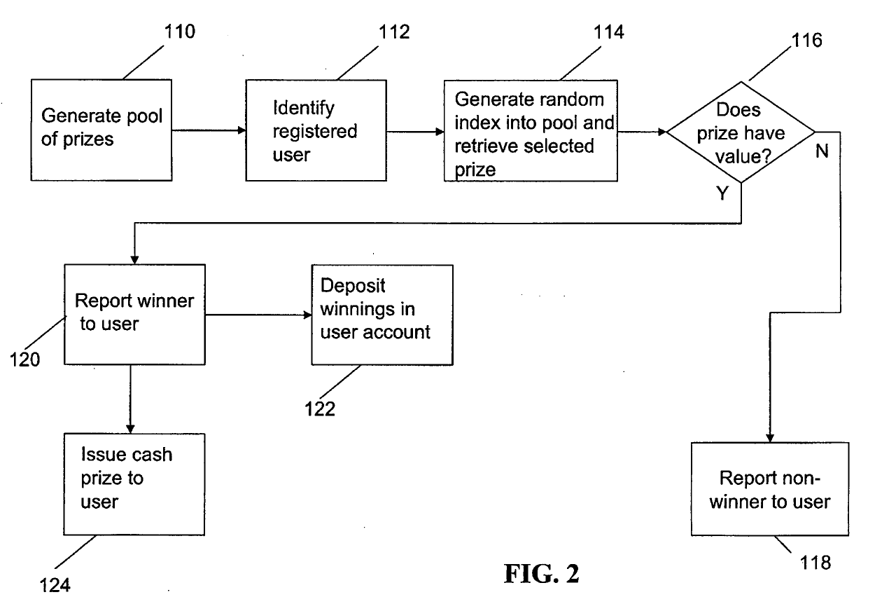

FIG. 2 illustrates steps involved in providing benefits in accordance with one embodiment of the present invention. As shown in FIG. 2, the system of the present invention generates a “pool” of prizes as at step 110, where the probability of winning any particular prize is indicated in the pool. In one embodiment of the present invention, the pool can be created by a rewards transaction processor 48 associated with rewards data processing system 42, as illustrated in FIG. 1. The pool may be depleting (i.e., when a prize is won it is removed from the pool), fixed (i.e., non-depleting and/or replenishing, where prizes are not removed) or a combination depleting/fixed (e.g., larger prizes replenished but smaller prizes removed once won). In one embodiment of the present invention, the pool is automated such that it can replenish, replace, shrink or append existing pools based on the desires of the sponsor running the benefit program. As an example, if the sponsor desires the pool to be replenished once a larger prize is won, the rewards transaction processor can run a pool management program to automatically add a new pool (with larger prizes now available) into the existing pool.

In one embodiment of the present invention, the rewards data processing system 42 is employed by a non-lottery sponsor organization such as a retailer, manufacturer or service provider seeking to incentivize more customers to use or experience their product or service. In such an embodiment, the prize pool can include all non-lottery prizes, all lottery-related prizes, or a combination of non-lottery and lottery-related prizes. In another embodiment of the present invention, the rewards data processing system 42 is employed by a lottery operator (e.g., a state lottery) to incentivize players to purchase more lottery tickets.

Regardless of embodiment, the pool selection options can be presented to a sponsor via a computer user interface. The sponsor computer would thus have access to the network 40 and rewards data processing system 42, wherein account management component 46 can run programming allowing the sponsor to establish a rewards program in accordance with the present invention. The sponsor can, for example, establish prizes to be included in its own pool of prizes, or can select prizes for its pool of prizes that can be made available by a prize providing entity such as a lottery provider, for example. In such a case, the selected prize pool would be limited by whatever limits the prize providing entity incorporates. For instance, in the lottery provider example, there may be a limit to the number of lottery tickets that can be made available in a prize pool. Financial arrangements for prizes provided by prize providing entities to a rewards sponsoring entity can be managed in accordance with business custom, and it is within the scope of the present invention to incorporate financial transaction processing capabilities to handle such financial arrangements as part of the rewards data processing system.

Continuing with respect to the process steps in FIG. 2, a registered user can be identified in connection with a transaction (step 112) in several ways. As described above, the user is provided with one or more personally identifying transaction instruments that can be “read” through elements of a point-of-sale terminal (e.g., barcode reader, scanner, magnetic stripe reader, browser interface for user name and password, etc.), a networked computer or mobile communications device, for example. Once the personally identifying transaction instrument is read during a transaction, information about the instrument and/or a corresponding personal identifier is delivered to the rewards transaction processing component 48 to determine the user account associated with the identifier. The “transaction” may be any of a number of transaction options, including, for example, purchases, exchanges, barters, redemptions and others. Further, the present invention accommodates transactions that are conducted without the personally identifying transaction instrument being directly used to conduct the transaction, such as where a standard credit or debit card is used for a purchase transaction, and the personally identifying transaction instrument is read separately but at generally the same time as the transaction takes place. Whether the personally identifying transaction instrument initiates/conducts the underlying transaction or is provided alongside a separate instrument that initiates/conducts the underlying transaction, the personally identifying transaction instrument is considered to be employed coincident with the transaction.

Upon identifying the user, the system of the present invention invokes rewards transaction processing component 48 to generate a random index into the pool of prizes, and retrieve a selected benefit that is awarded to the user instantly, as at step 114. In one embodiment of the present invention, the pool of prizes includes only winners and no non-winners, and prior to generating a random index into the pool of prizes, the present invention first determines whether a prize is to be issued at all. In another embodiment of the present invention, the pool of prizes includes both winners and non-winners, and the generation of a random index into the pool of prizes and the selection of a “prize” can in fact lead to a non-winning prize.

The prize can be, by way of example and not limitation, bonus points, cash, a discount (e.g., up to 100%) in the purchase price of the item or service being purchased, a merchandise prize and/or a voucher for free or discounted tickets in one or more lottery games. The prize need not be just one or two tickets, but can be hundreds or even thousands of tickets. Since the prize pool can include non-winners as noted above, it is possible that no benefit will be attached to the transaction. Thus, if it is determined at step 116 that the selected “prize” is a non-winner, the user is notified accordingly at step 118. If it is determined at step 116 that the selected prize is a winner, the user is notified at step 120, such as by written or spoken message delivered via the terminal at which the user has presented the personally identifying transaction instrument. In one embodiment of the present invention, the user is given the option of having any cash winnings applied to an account, as at step 122, or receiving cash on the spot as at step 124. The account can be a financial account accessed via financial data processing system or a financial account associated with the sponsor or prize-providing entity. For example, if a retailer is a sponsor and a lottery provider is the prize providing entity, a user of a credit charge card provided by the retailer can elect to have cash prize winnings credited to the retailer credit account, or credited to a lottery provider account.

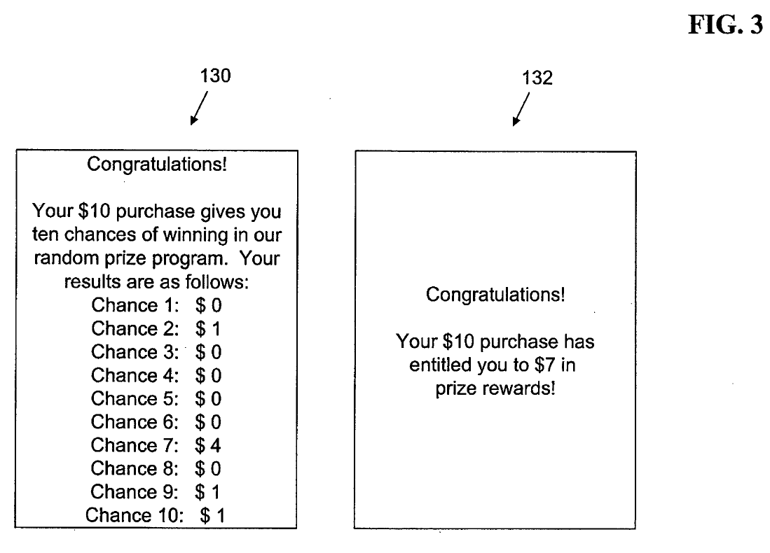

Prior to issuing the prize, one alternative embodiment of this aspect of the present invention alters the probability of winning a prize based on the purchase amount. For example, for each $1 in purchases, the buyer gets one chance to win an instant prize. If the buyer purchases $10 in merchandise in this example, the rewards transaction processor would then generate a random index into the pool of prizes ten times, and results could be presented to the buyer in individual form or in aggregate form. FIG. 3 illustrates example displays that can be presented to the user on a visual interface of the terminal where the personally identifying transaction instrument is presented in the present example, with interface 130 showing individual results for each of the ten chances, and interface 132 showing aggregate results for all ten chances.

Yet another embodiment alters the probability of winning based on other factors such as total points accumulated during a time period or purchase frequency, or frequency of past wins or losses (e.g., via a personalized guaranteed low-end prize structure). Multiple winning possibilities can be provided, some of which are offered by the store where the item is purchased or via membership in a group that offers a prize.

Sponsor registration for a rewards program in accordance with the present invention is described above. Individual or group player registration can be handled in many ways. References to “player” herein will be understood to mean individual players as well as player groups or syndicates. A player can register by telephone or online registration process, whereby the player can, for example, provide some level of identification detail such as contact information, and establish a rewards account. The player can receive and/or select a personally identifying transaction instrument at the time of registration. For example, the player may select a user name and password that can be used at any computing device that can be used to make purchases (e.g., through a browser). Upon receiving the request, the system of the present invention creates an account using player/account management component 46, and stores the user identification information along with personally identifying transaction instrument information in database 50. As shown in FIG. 1, the rewards data processing system 42 can include a customer relationship management component 52 for collecting and analyzing user details and a rewards/loyalty component 54 for storing and managing rewards and loyalty information, such as individual prizes available in prize pools provided in accordance with the present invention. The rewards transaction processing component 48 generates the pool of rewards as well as the random index into the pool to determine what reward or benefit will be provided upon the player initiating a transaction.

It will be appreciated that, while it is actually a human player or user who receives benefits upon using the transaction instrument in accordance with the present invention, the present invention can preserve anonymity for players, while also allowing many different entity types (e.g., retailer, individual, syndicate group, etc.) with different identifier types (e.g., card, mobile communication device, user name and password, etc.) to participate. Thus, while the present invention is described in connection with FIG. 1 as employing a terminal within a retail environment, it will be appreciated that a player may make purchases online and receive benefits in accordance with the present invention that are passed through rewards provider network 40. In the embodiment of the present invention where the transaction instrument is a multi-purpose transaction card, it is possible that the user may qualify for multiple random prizes from multiple prize pools at the same time. In one embodiment of the present invention where the transaction instrument is a stored value card, the terminal can communicate any winning cash amount directly to the card instead of a separate financial account.

With regard to biometrics, a fingerprint scanner (or other biometric information reader) can be attached as a peripheral to a terminal for the purpose of capturing a player's fingerprint (or other biometric information) at a retailer location Also as an option, an alpha/numeric keypad can be incorporated as either an additional peripheral or as part of the fingerprint scanner. It will be appreciated that a fingerprint scanner need not be the sole operative biometric device used in accordance with this aspect of the present invention. Other biometric equipment and techniques employed by the present invention can include, for example, iris recognition, retinal recognition, hand prints, voice recognition, facial recognition, signature stroke recognition or any combination thereof.

As described above, the account associated with the transaction instrument can be a financial institution account established by financial institution data processing system 76. In one embodiment of the present invention, if the winner does not have a financial institution account to deposit winnings, an account can be established by the rewards data processing system sending a communication to the financial institution data processing system 76 to open a new account. In one embodiment of the present invention, the account is established in the name of the prize winner. In another embodiment of the present invention, the account is established in the name of an account custodian, which can be the sponsoring entity or prize providing entity depending upon the user's selection. In yet another embodiment of the present invention, the financial institution account is opened using a wagering syndicate identifier so as to permit syndicate wagering as described elsewhere herein. The funds used to open the account can travel directly from the rewards data processing system operator (e.g., the state lottery holding the prize winnings won by the prize claimant) to the financial institution, such as by wire or other known method.

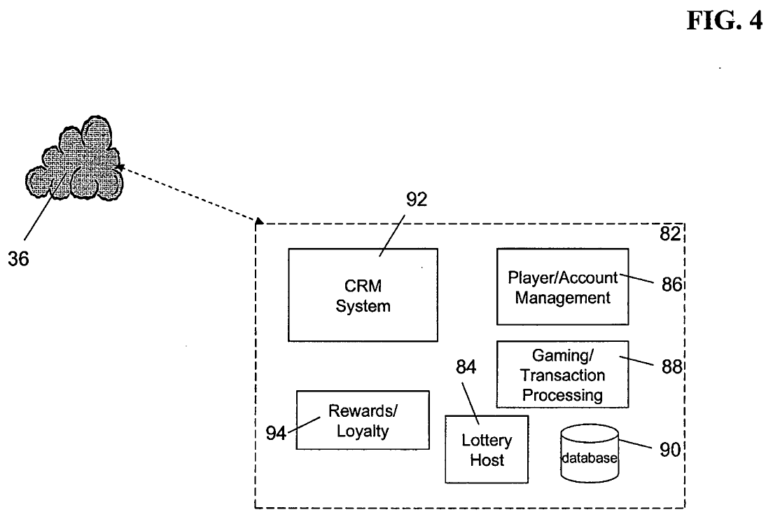

In the embodiment of the present invention where lottery tickets or other gaming plays are issued as the prize to a purchaser, it will be appreciated that the present invention can allow the purchaser to play the tickets and/or game on the terminal where the user has executed the previous purchase transaction. Awarded lottery tickets in the form of instant online lottery tickets may be issued and played over a terminal, where the terminal is connected to a lottery data processing system similar to the rewards data processing system in FIG. 1. FIG. 4 shows an example lottery data processing system 82 connected to network 36, which can incorporate lottery/gaming host 84, and can further coordinate and/or run various lottery service provider functions such as player and account management component 86, gaming/transaction processing component 88, database 90, lottery customer relationship management (CRM) component 92 and lottery loyalty rewards component 94. Lottery/gaming host 84 can include, for example, programming for validating winning tickets, generating ticket data, randomizing winners, benefits and prizes, managing games and communications. In one embodiment of the present invention, the lottery data processing system 82 manages deposits, withdrawals and gaming wagers and payouts via player/account management component 86. In another embodiment of the present invention, the lottery data processing system 82 can communicate with the financial system network 65 (see FIG. 1) to manage electronic funds transfers for similar purposes. For instance, the lottery data processing system 82 can communicate the winnings from a gaming event to the financial system network in order to add funds to a financial institution account associated with a player, retailer or other entity, as described in more detail hereinafter.

As with other instant winning prizes, any cash winnings from playing the rewarded lottery tickets can be transmitted from the lottery system operator to the user's financial account. In one embodiment of the present invention, the funding amount for the financial account is less than the actual prize winnings, because taxes, expenses, fees and any other deductions may be taken prior to the funds being deposited in the account. In a further embodiment of the present invention, the lottery data processing system 82 can issue a stored value card to the player, where the card is pre-loaded with the amount of transferred winnings. In yet another embodiment of the present invention, the lottery data processing system 82 can issue a debit card to the player, where the player has funds available in the amount of the winnings for both “open network” transactions, such as general credit card purchases, as well as lottery/gaming-related transactions. In such an embodiment, the funds can be managed in a financial account in the various ways described above. Further, in this embodiment of the present invention, once the funds are in the account, a clerk at the terminal where the personally identifying transaction instrument is presented and the resulting lottery game is played can employ a machine to convert either an existing or a newly issued transaction card to a value-applied transaction instrument (VATI). The machine can be a card writer that writes information to the transaction card via magnetic stripe, bar code, chip or other method, wherein the information associates the financial account with the card to enable the card to be used for purchase and other transactions (e.g., as a debit card).

In addition to being activated for transaction purposes, the VATI can be used by the user to establish favorite numbers, favorite wagers, and other personally appealing features using the CRM component 92 associated with the lottery data processing system 82 of the present invention. In one embodiment, the user can access a web site using the VATI and the user's PIN for such purposes, and can establish a lottery system account associated with the VATI and/or the player's name. The user can also elect for any future winnings from lottery gaming wins or other transactions to be applied to the account. Illustrative options for employing the VATI in accordance with the present invention are described in applicant's co-pending patent application Ser. No. 12/344,627, entitled “System, Device and Method for Paperless Wagering and Payment of Winnings”, the disclosure of which is incorporated herein by reference in its entirety.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. Aspects of the present invention may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A system, comprising:
at least one terminal adapted to identify an individual via a personally identifying transaction instrument;
a rewards network in communication with the at least one terminal; and
a rewards processing component in communication with the rewards network for generating and storing a pool of prizes, and further for generating a random index into the pool of prizes and retrieving a prize upon receiving an indication from the rewards network that the personally identifying transaction instrument has been employed coincident with a transaction.

2. The system of claim 1 wherein the prize pool is depleting.

3. The system of claim 1 wherein the prize pool is fixed.

4. The system of claim 1 wherein the retrieved prize is issued to an account associated with the personally identifying transaction instrument.

5. The system of claim 4 wherein the retrieved prize is a cash amount and wherein the cash amount is added to a financial account balance associated with the personally identifying transaction instrument.

6. The system of claim 1 wherein the personally identifying transaction instrument is a multi-purpose transaction card having indicia thereupon for initiating lottery and non-lottery transactions.

7. The system of claim 6 wherein the transaction card indicia includes first indicia for initiating a lottery transaction and second indicia for initiating a non-lottery transaction.

8. The system of claim 6 wherein the first and second indicia are the same.

9. The system of claim 6 wherein the at least one terminal reads the indicia on the transaction card and communicates instructions to the rewards processing component to generate a random index into the pool of prizes.

10. The system of claim 1 wherein the retrieved prize is at least one virtual lottery ticket, and wherein the terminal is employed to play the at least one lottery ticket.

11. The system of claim 10 wherein the play of the at least one lottery ticket results in cash winnings that are applied to a financial account associated with the personally identifying transaction instrument.

12. The system of claim 1 wherein the rewards processing component determines whether a prize is to be issued before generating the random index into the pool of prizes.

13. A method for issuing rewards in connection with transactions, comprising:
issuing a personally identifying transaction instrument to a user;
generating, by a rewards processing component, a pool of prizes capable of being won by a user of the transaction instrument;
receiving an indication from a terminal that the transaction instrument has been employed coincident with a transaction;
generating, by the rewards processing component, a random index into the pool of prizes; and
retrieving, by the rewards processing component, a prize that is issued to the user.

14. The method of claim 13 wherein the retrieved prize is issued to the user without paper or cash.

15. The method of claim 13 wherein the retrieved prize is a cash amount and wherein the cash amount is added to a financial account balance associated with the transaction instrument.

16. The method of claim 13 wherein the transaction instrument is a multi-purpose transaction card having indicia thereupon for initiating lottery and non-lottery transactions.

17. A terminal, comprising:
a reader element capable of identifying a user via a personally identifying transaction instrument; and
a communications component for communicating with a rewards processing component, with the rewards processing component capable of generating a pool of prizes and further capable of generating a random index into the pool of prizes and retrieving a prize to be issued to the user.

18. A system, comprising:
at least one terminal adapted for reading a transaction instrument;
a lottery rewards network in communication with the at least one terminal; and
a rewards processing component in communication with the lottery rewards network for generating a pool of lottery prizes, receiving an indication that the transaction instrument has been employed coincident with a transaction and, upon determining that a prize is to be issued, generating a random index into the pool of prizes and retrieving a lottery prize to be issued through the terminal.

19. The system of claim 18 wherein the transaction instrument is read without revealing personally identifying information of a user.

20. The system of claim 18 wherein the transaction instrument is a personally identifying transaction instrument that reveals personally identifying information when it is read.
